(19) United States
(12) Patent Application Publication
(10) Pub. No.: US 2014/0352664 A1
(43) Pub. Date: Dec. 4, 2014

(54) FLOW LIMITING SYSTEM

(71) Applicant: Caterpillar Inc., Peoria, IL (US)

(72) Inventors: Dana R. Coldren, Secor, IL (US); Dennis H. Gibson, Chillicothe, IL (US); Sana Mahmood, Fort Collins, CO (US); Sunil J. Bean, Peoria, IL (US)

(21) Appl. No.: 14/460,623

(22) Filed: Aug. 15, 2014

(51) Int. Cl. F02D 19/06

(52) U.S. Cl. CPC F02D 19/06
USPC 123/445

(57) ABSTRACT

The present disclosure is related to a flow limiting system for a dual fuel engine is disclosed. The flow limiting system includes a first valve configured to regulate a flow of a liquid fuel therethrough based on a pressure difference across the first valve. The flow limiting system further includes a second valve configured to regulate a flow of a gaseous fuel therethrough based on a pressure difference across the second valve. The second valve includes a valve body movably provided within a valve chamber. The valve body includes a control orifice extending therethrough. The valve body also includes grooves defined on an outer surface thereof.

### TECHNICAL FIELD

The present disclosure relates to a flow limiting system, and more specifically to a flow limiting system for a dual fuel engine.

### BACKGROUND

Dual fuel engines are well known in the art. A dual fuel engine is typically powered by a liquid fuel and a gaseous fuel. A single injector selectively sprays the liquid fuel and/or the gaseous fuel into an engine cylinder. The injector may malfunction in various manners during operation. Such malfunctions may result in an over-fuelling of the engine cylinder.

A flow limiting valve is typically provided to prevent over-fuelling of the engine cylinder by the liquid fuel. Such a flow limiting valve may not be suitable for use with the gaseous fuel due to differences between the gaseous fuel and the liquid fuel. For example, the liquid fuel provides lubrication to various components of the flow limiting valve. However, the gaseous fuel may not provide such lubrication. Therefore, various components of the flow limiting valve may undergo increased wear. Further, compressibility of the gaseous fuel may result in one or more over-fuelling cycles within the engine cylinder due to an amount of the gaseous fuel left downstream of the flow limiting valve after closure.

### SUMMARY OF THE DISCLOSURE

In one aspect of the present disclosure, a flow limiting system for a dual fuel engine is disclosed. The flow limiting system includes a first valve configured to regulate a flow of a liquid fuel therethrough based on a pressure difference across the first valve. The flow limiting system further includes a second valve. The second valve includes an intake conduit configured to receive a gaseous fuel. A valve chamber includes an intake end and a discharge end distal to the intake end. The valve chamber is in fluid communication with the intake conduit at the intake end. The second valve also includes a valve seat fixedly provided at the discharge end of the valve chamber. The valve seat includes a channel extending therethrough. The second valve includes a discharge conduit in fluid communication with the channel of the valve seat. The second valve also includes a valve body movably provided within the valve chamber. The valve body includes a control orifice extending therethrough. The control orifice is configured to regulate a position of the valve body between the intake end and the discharge end of the valve chamber based on a pressure difference between the intake conduit and the discharge conduit. The valve body also includes grooves defined on an outer surface thereof. The grooves are configured to regulate a flow pattern of the gaseous fuel around the valve body. The second valve also includes a spring member provided between the valve seat and the valve body. The spring member is configured to bias the valve body towards the intake end of the valve chamber. The valve body is configured to abut against the valve seat to prevent a flow of the gaseous fuel between the valve chamber and the channel of the valve seat in response to a first predetermined pressure difference between the intake conduit and the discharge conduit. The valve body is further configured to abut against the intake end of the valve chamber to present a flow of the gaseous fuel between the valve chamber and the intake conduit in response to a second predetermined pressure difference between the intake conduit and the discharge conduit.

Other features and aspects of this disclosure will be apparent from the following description and the accompanying drawings.

### BRIEF DESCRIPTION OF THE DRAWINGS

FIG. 1 is a schematic view of a dual fuel engine, according to an embodiment of the present disclosure;

FIG. 2 is a perspective view of a quill having a flow limiting system, according to an embodiment of the present disclosure;

FIG. 3 is a sectional view of the flow limiting system, according to an embodiment of the present disclosure; and

FIGS. 4, 5 and 6 are sectional views depicting various operational modes of the flow limiting system of FIG. 3.

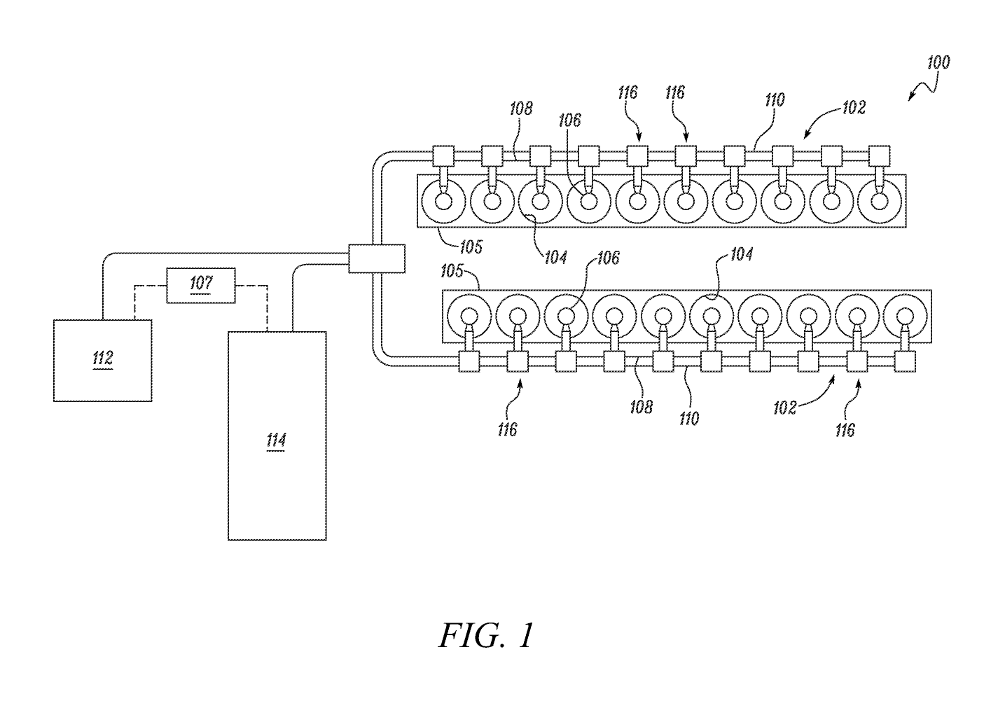

### DETAILED DESCRIPTION

Wherever possible, the same reference numbers will be used throughout the drawings to refer to the same or the like parts. Referring to FIG. 1, a schematic view of an exemplary dual fuel engine 100 is illustrated, according to an embodiment of the present disclosure. The engine 100 may be used in a variety of applications, for example, but not limited to, mining, construction, agriculture, transportation, power generation, marine applications, and so on. Further, the engine 100 may power various types of machines, such as a wheel loader, an excavator, a dump truck, a locomotive, a marine vessel, an electric generator and so on.

As illustrated in FIG. 1, the engine 100 includes a dual fuel rail system 102 that supplies fuel to multiple cylinders 104 provided in an engine housing 105. The dual fuel rail system 102 includes an injector 106 for each of the multiple cylinders 104. An electronic control module (ECM) 107 may regulate each of the injectors 106. In an embodiment, the injector 106 may include a liquid fuel control valve (not shown) and a gaseous fuel control valve (not shown) to regulate a flow of the liquid fuel and the gaseous fuel, respectively, to the respective cylinder 104. The liquid fuel control valve and the gaseous fuel control valve may be solenoid actuated valves controlled by the ECM 107. It may be contemplated that at any given time, the engine 100 may operate on the liquid fuel only, the gaseous fuel only, or any combination of the liquid fuel and the gaseous fuel. In an embodiment, the injector 106 may also include a liquid fuel check valve (not shown) and a gaseous fuel check valve (not shown) to selectively preclude a flow of the liquid fuel and the gaseous fuel based on whether the cylinder 104 is being supplied with the gaseous fuel and the liquid fuel, respectively. For example, the gaseous fuel check valve may open when the injector 106 sprays the gaseous fuel within the cylinder 104. Further, the gaseous fuel check valve may close to prevent a flow of the gaseous fuel to the injector 106 when the injector 106 is not supplying the cylinder 104 with the gaseous fuel.

Further, the dual fuel rail system 102 includes a liquid fuel common rail 108 and a gaseous fuel common rail 110 fluidly connected to each of the injectors 106. The liquid fuel common rail 108 is configured to supply each of the injectors 106 with a liquid fuel, for example, diesel. Further, the gaseous fuel common rail 110 is configured to supply each of the injectors 106 with a gaseous fuel, for example, compressed natural gas (CNG). The liquid fuel common rail 108 is in fluid communication with a liquid fuel supply system 112, while the gaseous fuel common rail 110 is in fluid communication a gaseous fuel supply system 114. In various embodiments, each of the liquid fuel supply system 112 and the gaseous fuel supply system 114 may include a fuel tank (not shown), one or more valves (not shown), one or more pumps (not shown), and so on. The gaseous fuel supply system 114 may also include an accumulator (not shown) and a vaporizer (not shown). The ECM 107 may regulate one or more components of the liquid fuel supply system 112 and the gaseous fuel supply system 114.

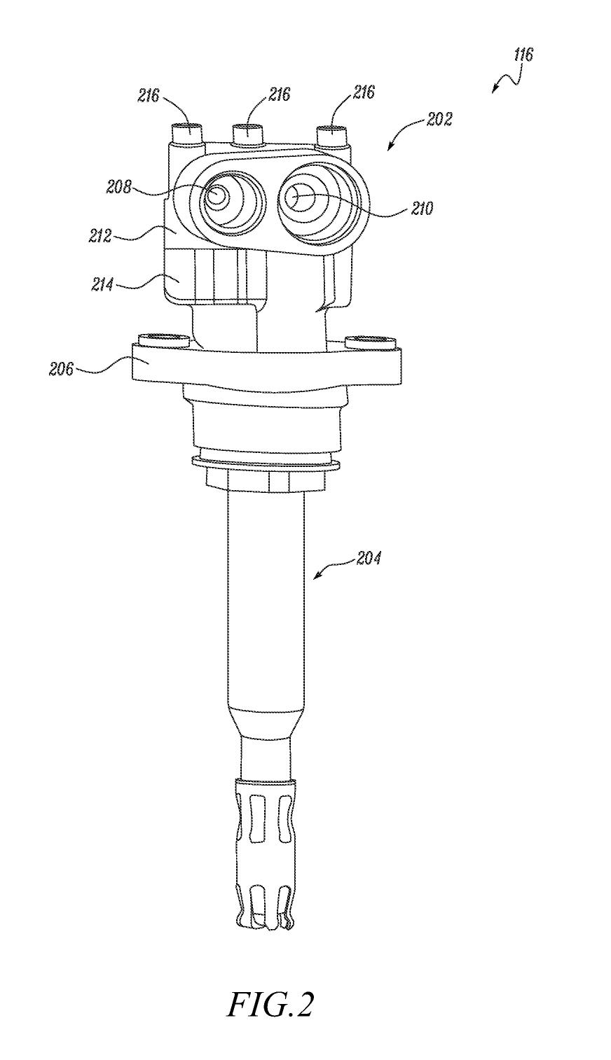

A quill 116 is provided between the liquid fuel common rail 108 and the gaseous fuel common rail 110, and each of the injectors 106. A flow limiting system 202 (shown in FIG. 2) may be provided in each of the quills 116 to regulate flows of the liquid fuel and the gaseous fuel to the injectors 106. Details of the flow limiting system 202 will be described henceforth.

FIG. 2 illustrates a perspective view of the quill 116, according to an embodiment of the present disclosure. The quill 116 includes the flow limiting system 202 and a tubular portion 204. A connecting portion 206 may be coupled to the engine housing 105 (shown in FIG. 1) by fasteners (not shown). The flow limiting system 202 includes a first inlet aperture 208 and a second inlet aperture 210 in fluid communication with the liquid fuel common rail 108 (shown in FIG. 1) and the gaseous fuel common rail 110 (shown in FIG. 1), respectively. In an embodiment, the tubular portion 204 may be a co-axial tube assembly having an inner tube (not shown) and an outer tube (not shown). The inner tube may be configured to supply the injector 106 (shown in FIG. 1) with the liquid fuel. Further, the outer tube (not shown) may be configured to supply the injector 106 with the gaseous fuel. Moreover, the flow limiting system 202 includes a first housing 212 and a second housing 214. The first and second housings 212, 214 may be coupled to each other by fasteners 216. Alternatively, the first and second housings 212, 214 may be coupled to each other by any other method known in the art, for example, welding, brazing, and so on. It may also be contemplated that the flow limiting system 202 includes a single integral housing (not shown).

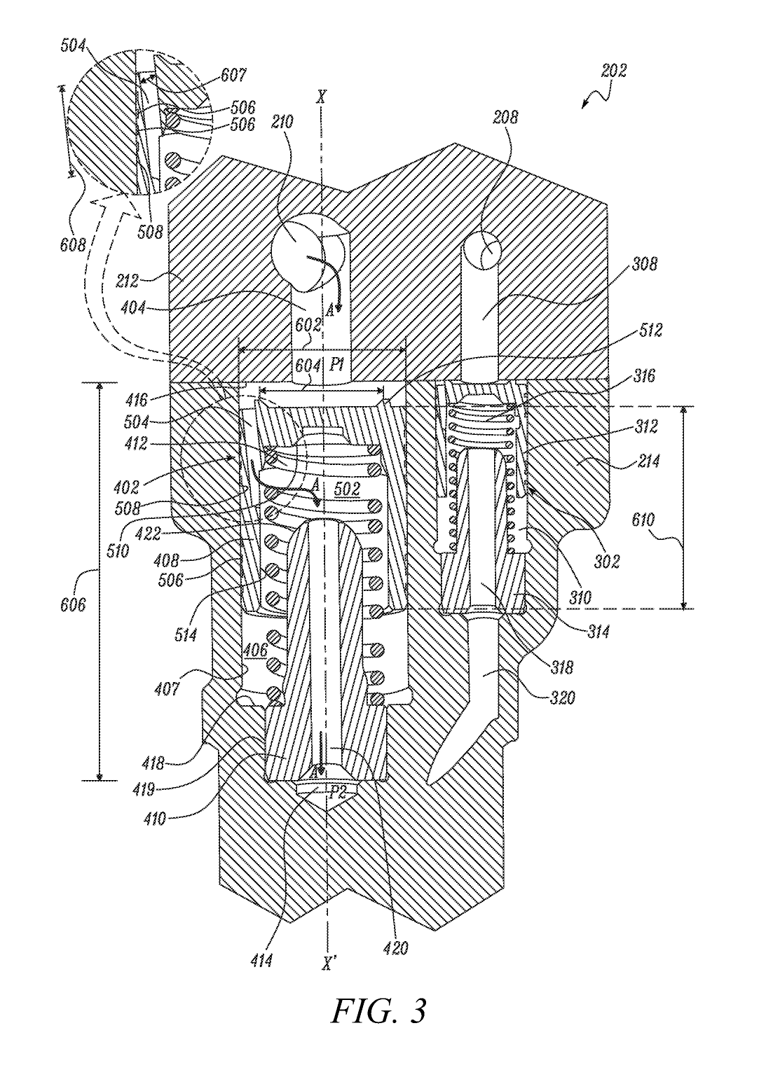

FIG. 3 illustrates a sectional view of the flow limiting system 202, according to an embodiment of the present disclosure. The flow limiting system 202 includes a first valve 302 and a second valve 402. The first valve 302 includes a first intake conduit 308 in fluid communication with the first inlet aperture 208. The first valve 302 further includes a first valve chamber 310, a first valve body 312, a first valve seat 314, and a first spring member 316. The first valve body 312 is movably provided within the first valve chamber 310. The first spring member 316 may bias the first valve body 312 away from the first valve seat 314. Further, the first valve seat 314 includes a first channel 318 in fluid communication with the first valve chamber 310 and a first discharge conduit 320. Further, the first discharge conduit 320 may in fluid communication with the inner tube of the tubular portion 204 (shown in FIG. 2) of the quill 116. As shown in FIG. 3, the various components of the first valve 302, except the first intake conduit 308, are provided within the second housing 214.

In an embodiment, the first valve 302 is configured to regulate a flow of the liquid fuel therethrough based on a pressure differential across the first valve 302. The pressure differential across the first valve 302 may be equal to a pressure differential between the first intake conduit 308 and the first discharge conduit 320. Further, a position of the first valve body 312 in the valve chamber 310 may be determined by the pressure differential across the first valve 302. As illustrated in FIG. 3, the first valve body 312 abuts against an end of the first valve chamber 310 adjacent to the first intake conduit 308. This may be due to a pressure in the first discharge conduit 320 being greater than a pressure in the first intake conduit 308. Therefore, a pressure in the liquid fuel common rail 108 (shown in FIG. 1) may be low and the engine 100 (shown in FIG. 1) may be operating only on the gaseous fuel. However, an operational mode of the first valve 302, as illustrated in FIG. 3, is exemplary, and the first valve 302 may have other operational modes.

The second valve 402 includes a second intake conduit 404, a second valve chamber 406, a second valve body 408, a second valve seat 410, a second spring member 412, and a second discharge conduit 414. The second intake conduit 404 is in fluid communication with the second inlet aperture 210 and is configured to receive the gaseous fuel. The second valve chamber 406 includes an intake end 416, and a discharge end 418 distal to the intake end 416. The intake end 416 and the discharge end 418 may include upper and lower walls, respectively, of the second valve chamber 406. The second valve chamber 406 may be defined by the upper wall, lower wall, and a lateral wall 407 extending between the upper wall and the lower wall. Further, the second valve chamber 406 is in fluid communication with the second intake conduit 404 at the intake end 416. The second valve seat 410 is fixedly provided at the discharge end 418 of the second valve chamber 406. The second valve seat 410 may be fixed to an intermediate portion 419 of the second housing 214 by various methods known in the art, for example, interference fit, welding, and so on. The intermediate portion 419 is located between the discharge end 418 of the second valve chamber 406, and the second discharge conduit 414. The second valve seat 410 includes a second channel 420 extending therethrough. The second channel 420 fluidly communicates the second valve chamber 406 with the second discharge conduit 414. The second valve seat 410 also includes a sealing portion 422. Further, the second discharge conduit 414 may in fluid communication with the outer tube of the tubular portion 204 (shown in FIG. 2) of the quill 116.

The second valve body 408 is movably provided within the second valve chamber 406. The second valve body 408 may be movable along a longitudinal axis X-X′ of the second valve 402. Further, the second spring member 412 is provided between the second valve seat 410 and the second valve body 408. In an embodiment, the second spring member 412 may be configured to bias the second valve body 408 towards the intake end 416 of the second valve chamber 406. The second spring member 412 is embodied as a coil spring. In an embodiment, the second spring member 412 may have a stiffness of about 5 N/mm. Further, the second spring member 412 may be preloaded by a force of about 30 N. As illustrated in FIG. 3, the various components of the second valve 402, except the second intake conduit 404, are provided within the second housing 214.

The second valve body 408 further defines an internal volume 502 therein. The second valve body 408 also includes a control orifice 504 extending therethrough. The control orifice 504 may fluidly communicate the internal volume 502 of the second valve body 408 and the second valve chamber 406. In an embodiment, the control orifice 504 may be configured to regulate a position of the second valve body 408 between the intake end 416 and the discharge end 418 of the second valve chamber 406 based on a pressure difference between the second intake conduit 404 and the second discharge conduit 414. The second valve body 408 may also include grooves 506 defined on an outer surface 508 thereof. The grooves 506 are illustrated as circular grooves in FIG. 3. However, the grooves 506 may also be helical grooves within the scope of the present disclosure. In an embodiment, the grooves 506 may be configured to regulate a flow pattern of the gaseous fuel around the second valve body 408. For example, the grooves 506 may induce a swirling motion to the gaseous fuel around the second valve body 408. Further, a diametrical clearance (not shown) may also be present between the outer surface 508 of the second valve body 408 and the lateral wall 407 of the second valve chamber 406. The second valve body 408 further includes a first sealing portion 510 defined on an internal surface 514, and a second sealing portion 512 projecting from the outer surface 508.

In an embodiment, the first sealing portion 510 may be configured to abut against the sealing portion 422 of the second valve seat 410 to prevent a flow (indicated by arrows “A”) of the gaseous fuel between the second valve chamber 406 and the second channel 420 in response to a first predetermined pressure difference between the second intake conduit 404 and the second discharge conduit 414. The first sealing portion 510 and the sealing portion 422 may have complementary conical, spherical, or a combination of conical and spherical shapes. In a further embodiment, the second sealing portion 512 may be configured to abut against the intake end 416 of the second valve chamber 406 to prevent a flow of the gaseous fuel between the second valve chamber 406 and the second intake conduit 404 in response to a second predetermined pressure difference between the second intake conduit 404 and the second discharge conduit 414. A pressure P1 of the gaseous fuel within the second intake conduit 404 may be substantially equal to a pressure of the gaseous fuel within the gaseous fuel common rail 110 (shown in FIG. 1). Further, a pressure P2 of the gaseous fuel within the second discharge conduit 414 may be substantially equal to a pressure of the gaseous fuel which is supplied to the injector 106 (shown in FIG. 1).

In an embodiment, a diameter 602 of the second valve chamber 406 may lie in a range from about 21 mm to 23 mm. The diameter 602 may be substantially equal to an outer diameter of the second valve body 408. Further, an inner diameter 604 of the second sealing portion 512 may lie in a range from about 16 mm to 17 mm. A length 606 of the second valve chamber 406 and the intermediate portion 419 may lie in a range from about 50 mm to 55 mm. Further, a diameter 607 of the control orifice 504 may lie in a range from about 1 mm to 2 mm. A length 608 of the control orifice 504 may lie in a range from about 2 mm to 4 mm. Further, a length 610 of the second valve body 408 along the longitudinal axis X-X′ may lie in a range from about 31 mm to 46 mm. Various combinations of the length 610 of the second valve body 408 and the diameter 602 of the second valve chamber 406 may be chosen such that a ratio between the length 610 and the diameter 602 may lie in a range from about 1.5 to 2. The ratio between the length 610 and the diameter 602 is henceforth called the L/D ratio of the second valve body 408.

The dimensional values, as described above, are exemplary in nature, and the various components of the second valve 402 may have any other dimensions within the scope of the present disclosure. Further, the configuration and/or design of the second valve 402, as shown in FIG. 3, are exemplary in nature, and alternate configurations and/or designs may be possible. For example, the second valve chamber 406 and the second valve body 408 may have any cross-section other than circular, such as polygonal, elliptical, and so on. Further, the dimensional values may be dependent on various parameters of the engine 100, for example, power generated by each of the cylinders 104.

### INDUSTRIAL APPLICABILITY

The present disclosure relates to the engine 100 that includes the liquid fuel common rail 108 and the gaseous fuel common rail 110. The liquid fuel common rail 108 and the gaseous fuel common rail 110 deliver the gaseous fuel and the liquid fuel, respectively, to each of the injectors 106 associated with each of the cylinders 104 of the engine 100. The flow limiting system 202 is provided to regulate flows of the gaseous fuel and the liquid fuel to the injector 106.

Various operational modes of the flow limiting system 202 will be described hereinafter with reference to FIGS. 3 to 6. Reference will also be made to FIGS. 1 and 2. FIG. 3 illustrates the engine 100 operating only on the gaseous fuel. Therefore, a pressure of the liquid fuel with the liquid fuel common rail 108 may be low. A pressure differential across the first valve 302 may he high enough to cause the first valve body 312 to abut against an end of the first valve chamber 310 adjacent to the first intake conduit 308. This may prevent a leakage of the gaseous fuel from the injector 106, downstream of the first valve 302, to the liquid fuel common rail 108.

FIG. 3 also illustrates a first operational mode of the second valve 402. The second valve body 408 is in a first intermediate position between the intake end 416 and the discharge end 418 of the second valve chamber 406. In an embodiment, the injector 106 may not inject gaseous fuel in this configuration of the second valve 402. The control orifice 504 may allow a flow of the gaseous fuel (as indicated by the arrows “A”) from the second valve chamber 406 to the internal volume 502 of the second valve body 408. The gaseous fuel may then flow to the second discharge conduit 414 via the second channel 420 of the second valve seat 410. The diametric clearance between the outer surface 508 of the second valve body 408 and the lateral wall 407 may also allow a flow of the gaseous fuel from the second intake conduit 404 to the second discharge conduit 414. Therefore, the pressure P1 within the second intake conduit 404 may be substantially equal to the pressure P2 within the second discharge conduit 414 as there is no injection of the gaseous fuel within the respective cylinder 104. The first intermediate position of the second valve body 408 may be determined by the stiffness and the preloading of the second spring member 412.

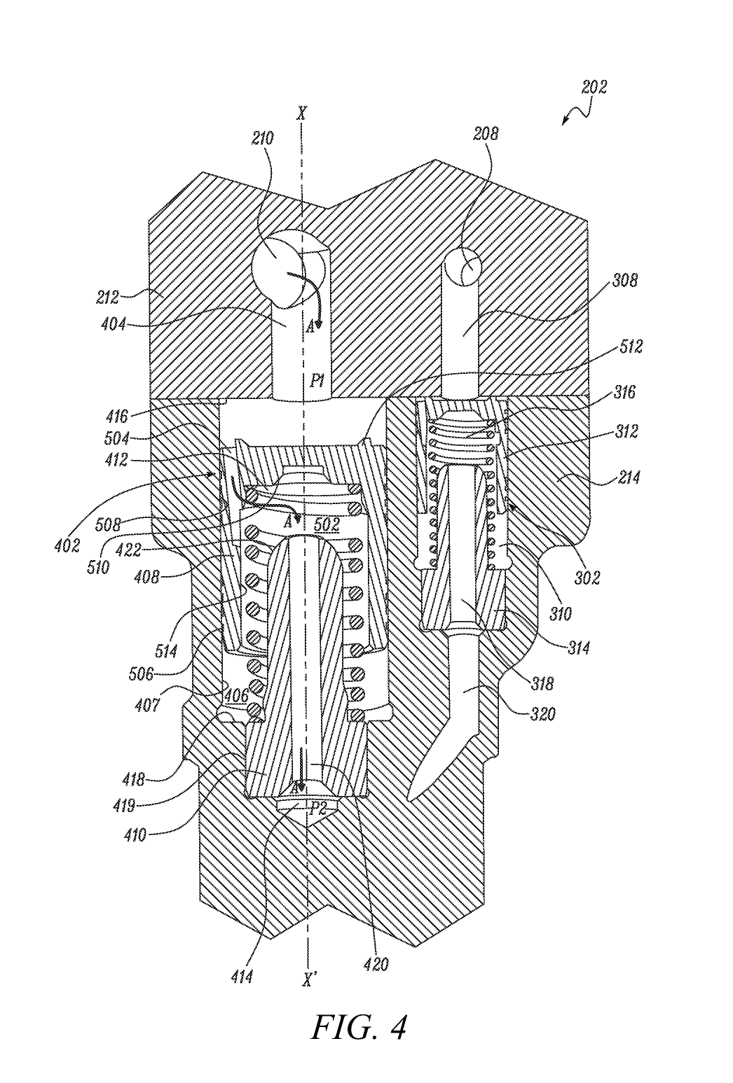

FIG. 4 illustrates a second operational mode of the second valve 402, according to an embodiment of the present disclosure. The engine 100 is operating only on the gaseous fuel and the operational mode of the first valve 302 may remain unchanged with respect to FIG. 3. In the second operational mode, as illustrated in FIG. 4, the second valve body 408 is in a second intermediate position between the intake end 416 and the discharge end 418 of the second valve chamber 406. In an embodiment, the second intermediate position may be more distal from the intake end 416 relative to the first intermediate position. In the second operational mode, the injector 106 may be injecting the gaseous fuel within the cylinder 104. Consequently, the pressure P2 within the second discharge conduit 414 may become lower than the pressure P1 within the second intake conduit 404. This pressure differential across the second valve body 408 may move the second valve body 408 to the second intermediate position. After the injection is over, the control orifice 504 and/or the diametrical clearance may raise the pressure P2 back to the level of the pressure P1 such that the second valve 402 switches back to the first operational mode. It may therefore be apparent that during normal operation of the injector 106, the first valve 302 may switch between the first and the second operational modes. The rate at which the second valve 402 moves back to the first operational mode may be determined at least by the dimensions of the control orifice 504, and/or a magnitude of the diametrical clearance. For example, the dimensions of the control orifice 504 may include the diameter 607 and the length 608. The control orifice 504 may also regulate the second intermediate position of the second valve body 408 between the intake end 416 and the discharge end 418 such that the second valve body 408 may not move beyond a distance from the first intermediate position during injection.

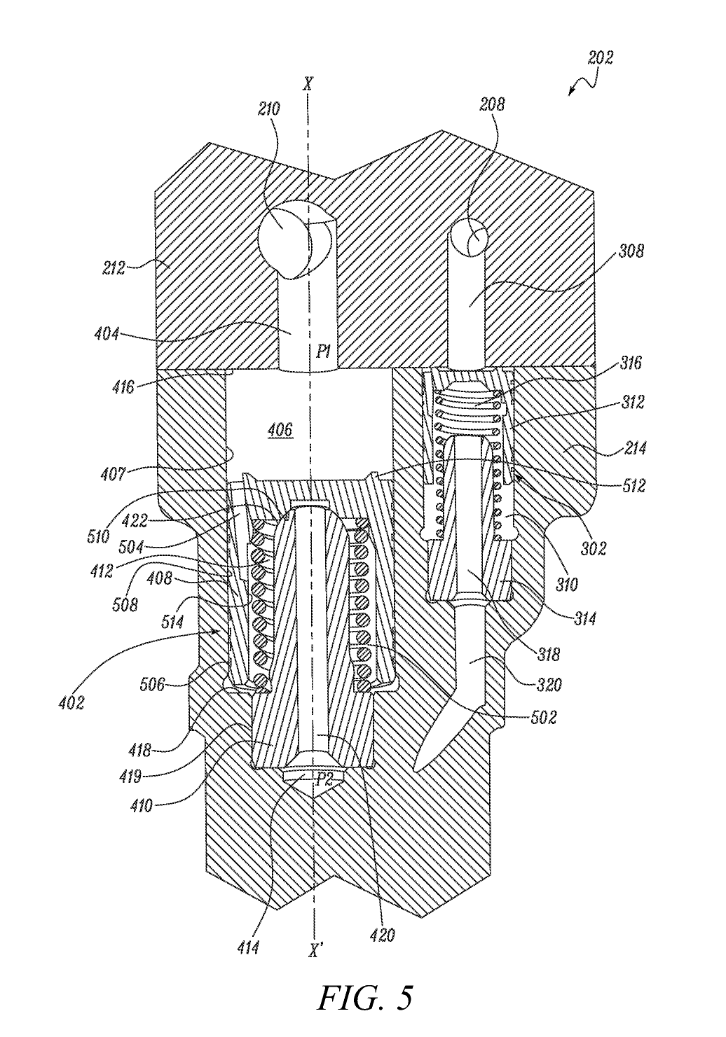

FIG. 5 illustrates a third operational mode of the second valve 402, according to an embodiment of the present disclosure. The engine 100 is operating only on the gaseous fuel and the operational mode of the first valve 302 may remain unchanged with respect to FIG. 3. In the third operational mode, the injector 106 may be malfunctioning. For example, the gaseous check valve may be stuck in an open position, and the injector 106 is injecting the gaseous fuel beyond a controlled amount within the cylinder 104. Consequently, the pressure P2 within the second discharge conduit 414 may decrease by a greater magnitude compared to a pressure drop during normal injection. A difference between the pressure P1 and the pressure P2 may become greater than or equal to the first predetermined pressure difference. Therefore, the second valve body 408 moves along the longitudinal axis X-X′ to a first sealing position. In the first sealing position, the first sealing portion 510 of the second valve body 408 may abut against the sealing portion 422 of the second valve seat 410. This may prevent a flow of the gaseous fuel between the internal volume 502 and the second channel 420. The complementary shapes of the first sealing portion 510 and the sealing portion 422 may improve a sealing between the second valve body 408 and the second valve seat 410. The second intake conduit 404 may be sealed from the second discharge conduit 414. An over-fuelling of the cylinder 104 with the gaseous fuel may therefore be prevented.

The L/D ratio of the second valve body 408 may be high, for example, within a range from about 1.5 to 2. A higher value of the L/D ratio may also tend to reduce an area of contact between the second valve body 408 and the lateral wall 407 of the second valve chamber 406. This in turn may reduce a wear of the second valve body 408 and the lateral wall 407. In an embodiment, a wear resistant coating may also be provided on the lateral wall 407 and/or the outer surface 508 of the second valve body 408. In an example, the wear resistant coating may be a diamond coating.

The grooves 506 may also serve to reduce the area of contact between the lateral wall 407 and the second valve body 408. The grooves 506 may provide a thin layer of the gaseous fuel between the outer surface 508 of the second valve body 408 and the lateral wall 407. This may help center the second valve body 408 within the second valve chamber 406, and avoid direct contact between the second valve body 408 and the lateral wall 407. In cases where the grooves 506 are helical, the grooves 506 may also induce a swirling motion to the gaseous fuel around the second valve body 408. The swirling motion may impart a spin to the second valve body 408, and prevent contact with the lateral wall 407 at a single location. Therefore, a wear of the second valve body 408 and the lateral wall 407 may be reduced.

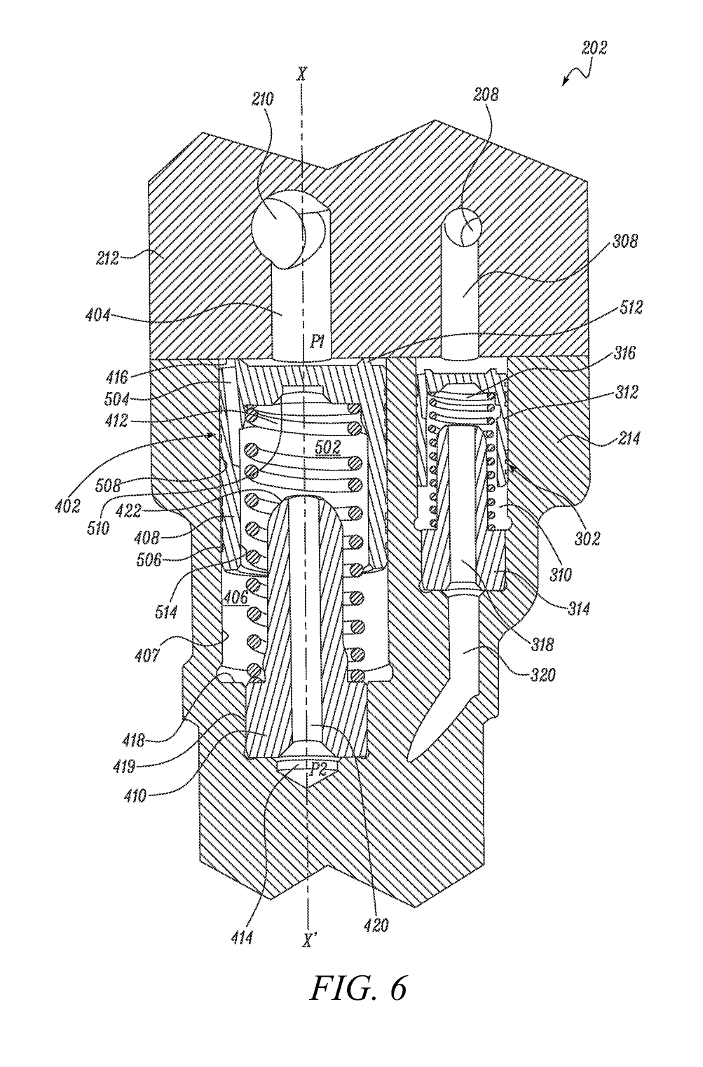

The dimensions of the control orifice 504, a cross-sectional area of the second valve 402, and the stiffness of the second spring member 412 may be chosen so as to optimize a reset time of the second valve 402. The reset time may be the time required by the second valve 402 to switch to the first operational mode from the third operational mode once the injector 106 becomes functional. The reset time may be such that the second valve 402 is in the first operational mode before an injection occurs. FIG. 6 illustrates a fourth operational mode of the second valve 402, according to an embodiment of the present disclosure. In the fourth operational mode, the engine 100 is operating only on the liquid fuel. As a result, the first valve body 312 may be in an intermediate position within the first valve chamber 310 in order to allow a flow of the liquid fuel from the first intake conduit 308 to the first discharge conduit 320. Further, the pressure P1 within the second intake conduit 404 may be low as the gaseous fuel common rail 110 is not providing any gaseous fuel. A difference between the pressure P2 and the pressure P1 may become greater than or equal to the second predetermined pressure difference. Consequently, the second valve body 408 moves to a second sealing position. In the second sealing position, the second sealing portion 512 of the second valve body 408 may abut against the intake end 416 of the second valve chamber 406. The second sealing portion 512, which protrudes from the outer surface 508 of the second valve body 408, may improve a sealing between the second valve body 408 and the intake end 416. The inner diameter 604 of the second sealing portion 512 may be chosen so as to improve the sealing. Consequently, a flow between the second valve chamber 406 and the second intake conduit 404 may be precluded. Thus, the second intake conduit 404 is sealed from the second discharge conduit 414. This may prevent a leakage of the liquid fuel from the injector 106, downstream of the second valve 402, to the gaseous fuel common rail 110.

The first valve body 312 may also selectively abut against the first valve seat 314 and prevent a flow of the liquid fuel between the first valve chamber 310 and the first channel 318 of the first valve seat 314 in order to prevent over-fuelling of the cylinder 104.

The various operational modes of the flow limiting system 202, as described above, may cater to various operational requirements of the engine 100 and/or malfunctions of the injector 106. Further, the flow limiting system 202 may also provide a compact arrangement such that the first and second valves 302, 402 may be in close proximity to the injector 106. Further, the first and second valves 302, 402 may independently regulate flows of the liquid fuel and the gaseous fuel, respectively.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A flow limiting system for a dual fuel engine, the flow limiting system comprising:
a first valve configured to regulate a flow of a liquid fuel therethrough based on a pressure differential across the first valve; and
a second valve comprising:
an intake conduit configured to receive a gaseous fuel;
a valve chamber comprising an intake end and a discharge end distal to the intake end, wherein the valve chamber is in fluid communication with the intake conduit at the intake end;
a valve seat fixedly provided at the discharge end of the valve chamber, wherein the valve seat comprises a channel extending therethrough,
a discharge conduit in fluid communication with the channel of the valve seat;
a valve body movably provided within the valve chamber, wherein the valve body comprises:
a control orifice extending therethrough, wherein the control orifice is configured to regulate a position of the valve body between the intake end and the discharge end of the valve chamber based on a pressure difference between the intake conduit and the discharge conduit; and
grooves defined on an outer surface thereof, wherein the grooves are configured to regulate a flow pattern of the gaseous fuel around the valve body; and
a spring member provided between the valve seat and the valve body,
wherein the spring member is configured to bias the valve body towards the intake end of the valve chamber;
wherein the valve body is configured to abut against the valve seat to prevent a flow of the gaseous fuel between the valve chamber and the channel of the valve seat in response to a first predetermined pressure difference between the intake conduit and the discharge conduit; and
wherein the valve body is further configured to abut against the intake end of the valve chamber to prevent a flow of the gaseous fuel between the valve chamber and the intake conduit in response to a second predetermined pressure difference between the intake conduit and the discharge conduit.
